(19) United States
(12) Patent Application Publication
(10) Pub. No.: US 2009/0188588 A1
(43) Pub. Date: Jul. 30, 2009

(54) APPARATUS AND METHOD FOR BARREL TOASTING

(75) Inventors: John Whiting, Hawthorn (AU); Graham Peacock, Grange (AU); Breck Waterman, Hawthorn (AU); Alan Conigrave, North Adelaide (AU)

Correspondence Address: WEINER & BURT, P.C., 635 N US-23, POB 186, HARRISVILLE, MI, 48740, US

(73) Assignee: Southern cross Cooperage PTY LTD, Netley (AU)

(21) Appl. No.: 12/301,234

(22) PCT Filed: May 17, 2007
(86) PCT No.: PCT/AU07/00666

§ 371 Date: Nov. 17, 2008

(30) Foreign Application Priority Data
May 17, 2006 (AU) 200620275

(51) Int. Cl. B27H 5/08

(52) U.S. Cl. 147/1; 432/224; 432/9

(57) ABSTRACT

The present invention discloses an apparatus and method of barrel toasting. In particular, an apparatus and method for consistently toasting the inside surface of a barrel, generally a barrel made of oak. Barrel toasting has traditionally been carried out on a barrel by barrel basis, by the cooper, according to wine or spirit-makers' specifications. The cooper draws upon his/her experience in order to determine the length of time and intensity of heat the barrel should be subjected to, so that the barrel is subjected to a reasonably consistent light, medium, medium plus or heavy toast. The present invention attempts to provide an apparatus and method for repeatability and uniformity in barrel toasting by monitoring the temperatures of the barrel being toasted and comparing these against a predetermined optimum range.

### FIELD OF THE INVENTION

The present invention relates to apparatus and method of barrel toasting. In particular, an apparatus and method for consistently toasting the inside surface of a barrel, generally a barrel made of oak.

### BACKGROUND OF THE INVENTION

The extent of barrel toasting has traditionally been determined on a barrel by barrel basis, by the cooper, according to wine and spirit-makers' specifications. The cooper draws upon his/her experience in order to determine the length of time and intensity of heat the barrel should be subjected to, so that the barrel is subjected to a reasonably consistent light, medium, medium plus or heavy toast. These classifications of toasting levels are judged both by the cooper's eye, from the colour of the wood, and the length of time the barrel was exposed to the heat source. As a result of this subjective process, carried out by different coopers, there exists great variance in toasted barrels available to wine and spirit-makers.

Oak trees are harvested and the wood is cut or split into staves to be stored and dried for varying lengths of time, up to approximately three years. An oak barrel is formed from these dried staves, with each stave possibly originating from a different oak tree with a different age and moisture content. Oak wood is used for barrels as it contains certain aromatic compounds desirable for wine or other alcohols stored within the barrels. These compounds provide the wine with qualities such as vanilla, smoky and spicy flavours and aromas. The toasting process exposes more of these desirable flavours and aromas in the oak by caramelising sugars, reducing tannin and bitterness, and creating aromatic aldehydes.

Prior to a cooper toasting an oak barrel as an individual and separate process, the staves were traditionally subjected to a heat source in order to enable the construction of the barrel. The staves would be heated and moistened so that they could be more easily bent and metal bands would then be applied to form the barrel shape. At some stage during the history of barrel making, coopers and wine and spirit-makers discovered that the toasting process enhanced the flavour of the wine produced and hence they sought to develop processes where this enhanced flavour was consistently achieved.

The toasting process involves placing a barrel over a heat source, generally a furnace containing oak barrel off cuts, for a particular length of time. The heat source applied to the interior surface of the barrel alters the chemical composition of the oak wood, bringing out different flavours and aromas. Different compounds are released or increased in concentration within the wood depending on whether these compounds were initially found in the wood and the toasting intensity and duration. The toasting intensity, or temperature of the target surface, is of particular importance in producing these compounds and for consistency the temperature needs to be monitored.

The flavours and aromas, formed by the chemical compounds found in the oak after toasting, then become available for extraction by the wines or alcohols stored within the barrel. The amount of flavours and aromas found in the wood depends on the extent that this chemical alteration process has permeated the wood and is determined by the length of time the oak is subjected to the heat source, as well as the intensity of the heat source and the moisture content of the wood. Wine and spirit-makers are seeking deeper penetration depths for the chemical alteration of the wood as this allows for more flavours to be extracted over a longer period of time. It has been found that up to 70% of the oak's flavours are extracted from the wood in the first year of aging wine in that barrel, with the remaining flavours extracted at an exponentially reducing rate.

These traditional methods of toasting are not highly uniform or reproducible. The cooper needs to use his/her expertise to build a fire to what is perceived as the desired temperature and place the barrel over the fire for a desired length of time. The cooper then may rotate the barrel about its central axis, flip it over or moisten the barrel in order to maintain the desired heat and moisture levels for consistent barrel toasting and chemical alteration. If the cooper subjects the barrel surface to too much heat in one particular area by not turning or flipping the barrel over, the wood can burn and form blisters. These blisters are undesirable as they affect the sanitation of the barrel by allowing the stored wine to reside behind the blistered and splintered wood. Conversely, too little heat results in not enough flavours and aromas being extracted by the wine or spirit.

Advancements on the traditional methods of toasting have attempted to standardise the heating and moisturising processes. One method is to rotate the barrel at a constant speed, about a centrally located heat source, thus ensuring that consistent surface toasting occurs. Also, additional moisture may be added at predetermined intervals to assist with the consistent production of flavours and aromas. Other methods are to use alternative heating sources, such as electric heating elements, hot air or gas, to ensure that heat is applied fairly consistently over the interior surface of the barrel. However, these alternate heating sources can produce a different toasting outcome to a traditional wood fire as different chemical modifications can occur in, and on the surface of the wood, ultimately altering the flavours available to the wine and potentially introducing flavours and aromas not desirable to the wine and spirit-maker.

It can be seen that due to the variations in the oak and the lack of repeatability and uniformity in the prior art toasting methods, there exists a difficulty for the cooper to achieve a consistent and reproducible chemical change in the wood. This inturn makes it difficult for winemakers to impart consistent and desirable flavours on the wine produced.

It is therefore an object of the present invention to reduce the variability and overcome the aforementioned problems in order to provide the public with a useful alternative.

### SUMMARY OF THE INVENTION

Therefore in one form of the invention there is proposed an apparatus for toasting wooden barrels for the purpose of altering the chemical composition of said barrel's wood including:

a means of heating an internal surface of said barrel being toasted;
a means of measuring temperature inside said barrel;
a means of measuring temperature outside said barrel; and
a means of comparing measured temperatures with predetermined results and
adjusting the temperature of said means of heating accordingly.

Preferably said means of comparing measured temperatures includes a computing means adapted to contain predetermined temperature ranges including; upper and lower temperature limits over a desired length of time, for each barrel toasting profile for each said barrel.

Preferably said computing means is adapted to compare a measured inside and outside barrel temperature, measured by said means of measuring temperature inside and outside said barrel, with said predetermined temperature ranges at predetermined time intervals.

Preferably said computing means outputs a series of instructions after comparing the measured and predetermined temperatures.

Preferably said series of instructions results in a plurality of visual indicators indicative of a required action of an operator, said visual indicators correspond to the operator:

removing the barrel from the means of heating;
increasing the temperature immediately of the means of heating;
increasing the temperature of the means of heating;
suppressing the temperature immediately of the means of heating;
suppressing the temperature of the means of heating;
maintaining the temperature of the means of heating; and
turning the barrel over 180 degrees.

Preferably said means of heating comprises of a bin adapted to contain wood for burning, preferably said wood is of the same variety as the barrel.

In preference said apparatus includes a means of supporting said barrel so that said means of heating is applied to the internal surface of the barrel being toasted and said means of supporting the barrel is adapted to rotate the barrel about the heating means.

Preferably said means of measuring temperature inside the barrel is adapted to measure a temperature internal to the barrel at a height of two thirds the barrel.

Preferably said means of measuring temperature outside the barrel is adapted to measure a temperature external to the barrel at a height of one half the barrel.

Preferably each said barrel is given a unique serial number.

Preferably said computing means contains a record of data of said measured temperatures over said desired length of toasting time for the barrel and said record of data is assigned to the unique serial number.

Therefore in a further form of the invention there is proposed a method of toasting a barrel comprising the steps of:

heating an internal surface of the barrel being toasted;
rotating said barrel about a means of heating said internal surface of the barrel; measuring internal and external temperatures of said barrel at predetermined time intervals;
comparing said measured internal and external temperatures of said barrel with predetermined temperatures at predetermined time intervals; and
analysing said compared temperatures and adjusting the temperature of the means of heating accordingly.

Preferably said method of adjusting the temperature is performed by an operator reacting to a series of instructions resulting from the method of analysing compared temperatures.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1 illustrates a perspective view of the apparatus for toasting a barrel, including a cut away section of the barrel exposing the furnace; and

FIG. 2 illustrates a sample display screen of the temperature monitored over time by the apparatus for toasting a barrel.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention.

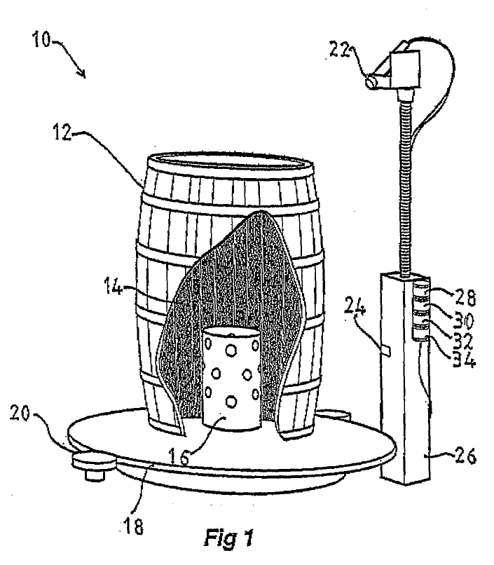

The present invention refers to an apparatus and method for toasting a barrel, in particular the toasting of the interior surface of a barrel, made of oak, for the purpose of wine or alcohol storage. FIG. 1 shows the apparatus for the toasting of a barrel 10, as it appears to the operator, without displaying any hardware associated with the coordination of the toasting process.

A barrel 12 generally made from oak and comprised of staves of different size and age, is placed vertically over a furnace 16. The furnace 16 is located centrally within the barrel so as the interior surfaces of the barrel staves 14 are subjected to an even amount of heat. The barrel 12 is able to be placed vertically over the furnace 16 as the end pieces, used to seal the barrel, are not fitted at this stage of barrel production. The end pieces are fitted to the barrel 12 after the toasting process is complete and they themselves can be toasted in a separate process. Off cuts of oak, from the barrel making process, are the desired fuel for the furnace 16 and a fire made of this oak is built and stoked to a desired temperature before the barrel 12 is placed over the furnace 16.

The barrel 12 is mounted centrally and vertically on top of a circular platform 18, adapted to be rotated. The rotation of the circular platform 18 is performed, in this embodiment, by a motor 20 adapted to frictionally rotate the platform. The motor 20 is configurable so that the rotational speed of the barrel can be varied depending on the type and size of barrel, as well as the type and intensity of the heat source. The barrel 12 rests centrally on the rotating platform 18, applying a gravitational force. This force is sufficient to retain the barrel in its correct position whilst rotating about the furnace 16. The platform 18 contains a central aperture, not shown, for the furnace 16 to be located so that it is fixed in position and does not rotate.

Mounted adjacent and separate to the rotating platform is the instrument stand 26. The stand 26 contains, mounted upon it, adjustable temperature sensors 22 and 24 and a series of coloured light emitting devices 28, 30, 32, and 34. The coloured light emitting devices are used to indicate to the operator the status of the barrel being toasted. This is achieved through displaying a known sequence of coloured lights, each indicating an action for the operator to attend to. The coloured light sequences are formed by illuminating the followed coloured lights; green 28, red 30, yellow 32 and blue 34.

The temperature sensors are used for monitoring the temperature within the barrel 12 and the temperature transmitted through the barrel staves 14. Hence, the method of toasting has the capability of monitoring the inside and outside temperatures of the barrel 12 being toasted. This is achieved by mounting the inside barrel temperature measuring sensor 22 at the top of the stand 26 and angled so as to read the temperature at a position located centrally within the barrel, at a height of approximately two thirds the barrel. The outside barrel temperature measuring sensor is mounted on the stand 26 and located at such as position so as to measure the temperature at a position of one half the height of the barrel. These locations for temperature measurements, in respect to the barrel, were selected to give the most accurate temperature readings both inside and outside the barrel.

To ensure that barrel toasting is achieved within the predetermined temperature profile, an operator must react to a series of instructions. Input from the temperature sensors 22 and 24 allows the internal and external temperatures of the barrel to be plotted against a predetermined temperature profile, with upper and lower limits for both internal and external temperatures. The operator is instructed to perform a particular task when the measured temperature of the barrel 12 approaches or exceeds the upper or lower limits of the predetermined temperature band. These tasks are conveyed to the operator by a combination of coloured lights; green 28, red 30, yellow 32 and blue 34.

When a red light 30 is displayed, in addition to any one or two other lights so as a total of two or three lights are displayed, the operator should then turn the barrel over immediately. A request for turning the barrel over generally occurs at predetermined time intervals, subject to the temperature achieved.

When a blue light 34 is displayed on its own, the operator is instructed to increase the temperature of the heating source immediately as the measured temperature has fallen beneath the lower tolerance limit. An increase in temperature is achieved by placing more fuel into the fire.

When a green light 28 is displayed on its own, the operator should do nothing as the measured temperatures fall within the desired temperature profile.

When both green 28 and blue 34 lights are displayed, the operator is to increase the temperature of the heating source as the measured temperature is approaching its lower limit.

When both green 28 and yellow 32 lights are displayed, the operator is to decrease the temperature of the heating source as the measured temperature is approaching its upper limit.

When a yellow light 32 is displayed on its own, the operator is instructed to decrease the temperature of the heating source immediately as the measured temperature has fallen above the upper tolerance limit. The operator can achieve this by spraying water onto the fire.

When all four lights, green 28, red 30, yellow 32 and blue 34, are displayed simultaneously, the barrel 12 has finished its toasting process and is to be removed immediately from the heat source.

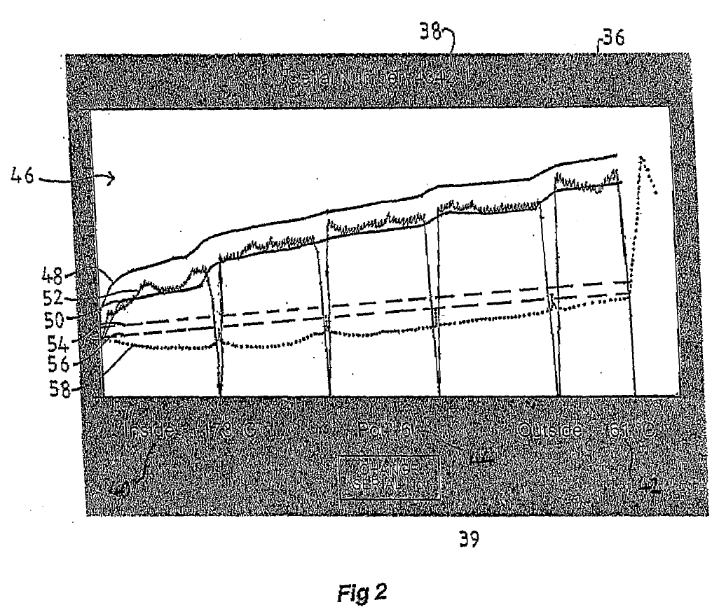

Shown in FIG. 2 is a sample display screen 36 from the software used to configure the toasting process and monitor the temperatures on both the inside and outside of the barrel 12 to compare with the predetermined optimum toasting profile. Displayed on this screen is a unique serial number 38 given to each barrel 12, in this example 4342-1. Also displayed is the ability to change the serial number 39.

This serial number enables the software to keep a record of individual barrel toasting profiles from the temperatures monitored and recorded. This enables the barrel toasting process to be highly traceable and reproducible even where the resultant toasting profile may not have been intentional. For instance, a wine or spirit-maker may like the flavours and aromas, extracted by the wine, from a particular barrel that for some reason has a toasting profile outside the predetermined optimum levels. The wine or spirit-maker may quote the unique serial number and request the cooper to produce another barrel with the same toasting characteristics.

The instantaneous temperature readings taken from the temperature sensors 22 and 24 are displayed on the sample screen 36. The inside barrel temperature is measured by the sensor 22 and is shown in this example, in field 40, to be 173 degrees Celsius. The outside barrel temperature is measured by the sensor 24 and is shown in this example, in field 42, to be 61 degrees Celsius.

The software, in this embodiment, used to configure and provide instructions to the operator, has the ability to monitor more than one barrel being toasted at one time. In the sample screen 36, the barrel 12 being toasted and monitored is placed over the furnace 16 labelled as Pot: 6 in field 44. The software is configurable so that each toasting station or pot has the ability to be set up with a different toasting configuration.

Displayed in field 46 is the graphical representation of the temperatures, both desired and measured, over time. Temperature is displayed on the y axis and time on the x axis. Shown in this figure are the upper 48 and lower 50 bands indicating the desired inside barrel temperature profile for a particular toasting profile. The toasting profile is dependent on the size of the barrel, type of barrel, and the level of toasting required. Line 52 is the actual inside temperature of the barrel 12 being toasted over time. It can be seen from this example that the operator has endeavoured to keep the inside temperature within the desired limits.

Shown as a dashed line are the upper 54 and lower 56 desired outside temperature limits. Dotted line 58 is the actual recorded outside temperature, measured by sensor 24 and plotted over time. From this graphical representation, it can be seen that the outside barrel temperature was below the lower temperature band for the duration of the toasting process. The temperatures recorded by the sensors 22 and 24 are taken at regular intervals, in this example every five seconds, to more accurately plot and compare the recorded and predetermined temperatures. This gives the cooper greater accuracy in reproducing individual toasting characteristics and chemical composition of a barrel.

At regular intervals the barrel is rotated or turned over by the operator and this is seen on graph 46 by the sudden drops in measured inside barrel temperatures and increases in outside barrel temperature. Also, it can be seen from the graph 46 that after the toasting process has completed, the outside barrel temperature sensor 24 detects an increase in heat from the furnace as there is no barrel insulating the sensor from the heat source.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. An apparatus for toasting wooden barrels for the purpose of altering the chemical composition of said barrel's wood including:
a means of heating an internal surface of said barrel being toasted;
a means of measuring temperature inside said barrel; a means of measuring temperature outside said barrel; and
a means of comparing measured temperatures with predetermined results and adjusting the temperature of said means of heating accordingly.

2. An apparatus as in claim 1, wherein said means of comparing measured temperatures includes a computing means adapted to contain predetermined temperature ranges including; upper and lower temperature limits over a desired length of time, for each barrel toasting profile for each said barrel.

3. An apparatus as in claim 2, wherein said computing means is adapted to compare a measured inside and outside barrel temperature, measured by said means of measuring temperature inside and outside said barrel, with said predetermined temperature ranges at predetermined time intervals.

4. An apparatus as in claim 2, wherein said computing means outputs a series of instructions after comparing the measured and predetermined temperatures.

5. An apparatus as in claim 4, wherein said series of instructions results in a plurality of visual indicators indicative of a required action of an operator, said visual indicators correspond to the operator:
removing the barrel from the means of heating;
increasing the temperature immediately of the means of heating; increasing the temperature of the means of heating;
suppressing the temperature immediately of the means of heating;
suppressing the temperature of the means of heating;
maintaining the temperature of the means of heating; and
turning the barrel over 180 degrees.

6. An apparatus as in claim 1, wherein said means of heating comprises a bin adapted to contain wood for burning, preferably said wood is of the same variety as the barrel.

7. An apparatus as in claim 1, wherein said apparatus includes a means of supporting said barrel so that said means of heating is applied to the internal surface of the barrel being toasted and said means of supporting the barrel is adapted to rotate the barrel about the heating means.

8. An apparatus as in claim 1, wherein said means of measuring temperature inside the barrel is adapted to measure a temperature internal to the barrel at a height of two thirds the barrel.

9. An apparatus as in claim 1, wherein said means of measuring temperature outside the barrel is adapted to measure a temperature external to the barrel at a height of one half the barrel.

10. An apparatus as in claim 2, wherein each said barrel is given a unique serial number.

11. An apparatus as in Claim 10, wherein said computing means contains a record of data of said measured temperatures over said desired length of toasting time for the barrel, and said record of data is assigned to the unique serial number.

12. A method of toasting a barrel comprising the steps of:
heating an internal surface of said barrel being toasted;
rotating said barrel about a means of heating said internal surface of the barrel;
measuring internal and external temperatures of said barrel at predetermined time intervals;
comparing said measured internal and external temperatures of said barrel with predetermined temperatures at predetermined time intervals; and
analysing said compared temperatures and adjusting the temperature of the means of heating accordingly.

13. A method as in claim 12, wherein said method of adjusting the temperature is performed by an operator reacting to a series of instructions resulting from the method of analysing compared temperatures.

14. An apparatus as in claim 3, wherein said computing means outputs a series of instructions after comparing the measured and predetermined temperatures.

15. An apparatus as in claim 14, wherein. said series of instructions results in a plurality of visual indicators indicative of a required action of an operator, said visual indicators correspond to the operator:
removing the barrel from the means of heating;
increasing the temperature immediately of the means of heating;
increasing the temperature of the means of heating;
suppressing the temperature immediately of the means of heating;
suppressing the temperature of the means of heating;
maintaining the temperature of the means of heating; and
turning the barrel over 180 degrees.

16. An apparatus as in claim 2, wherein said means of measuring temperature inside the barrel is adapted to measure a temperature internal to the barrel at a height of two-thirds the barrel.

17. An apparatus as in claim 2, wherein said means of measuring temperature outside the barrel is adapted to measure a temperature external to the barrel at a height of one-half the barrel.

18. An apparatus as in claim 3, wherein each said barrel is given a unique serial number.

19. An apparatus as in claim 18, wherein said computing means contains a record of data of said measured temperatures over said desired length of toasting time for the barrel, and said record of data is assigned to the unique serial number.

20. An apparatus as in claim 3, wherein said means of measuring temperature inside the barrel is adapted to measure a temperature internal to the barrel at a height of two-thirds the barrel.
